(19) United States
(12) Patent Application Publication
(10) Pub. No.: US 2006/0000518 A1
(43) Pub. Date: Jan. 5, 2006

(54) Apparatus for inerting the headspace of a container

(76) Inventors: Donald Allen, Elizabeth SA (AU); Roman Kluba, Elizabeth SA (AU); Graham Sumner, Elizabeth SA (AU)

Correspondence Address: Linda K. Russell, Suite 1800, 2700 Post Oak Blvd., Houston, TX, 77056, US

(21) Appl. No.: 11/158,182

(22) Filed: Sep. 7, 2005

(30) Foreign Application Priority Data
Jun. 21, 2004 (AU) 2004903403
May 19, 2005 (AU) 2005202150

(51) Int. Cl. B67C 3/02

(52) U.S. Cl. 141/67

(57) ABSTRACT

Methods and apparatus for supplying an inert compound into the head space of a container. The apparatus has a delivery path which is made up of an inlet which receives a mixture of gaseous phase and solid phase inert compound, an outlet and a tortuous section. The tortuous section is located between the inlet and the outlet, and is situated so as to reduce the velocity of the solid phase inert compound as it passes through. The inert compound can then be delivered into the head space of a container at a lower velocity which increases the efficiency of the inert gas in displacing any air present.

### FIELD OF THE INVENTION

This invention relates to a method and apparatus for producing an inert atmosphere above a product stored in a container. The invention is particularly applicable in the food industry where contact with atmospheric oxygen may cause deterioration of a food product. However, the invention is not limited to this particular field of use.

### BACKGROUND OF THE INVENTION

Many liquid products and particularly beverages are susceptible to damage or deterioration when mixed with or exposed to gaseous oxygen (usually oxygen present in air) for a period of time. Some O₂ may dissolve in the liquid and react with one or more of the chemical constituents causing undesirable changes such as flavour deterioration, aroma deterioration, colour change, formation of undesirable colour, hazing, browning and so on.

These changes are of particular concern to the beverage industries producing beer, wines, soft drinks, fruit juices, etc. The quantity of dissolved O₂ required to produce a slight but noticeable flavour deterioration in certain types of beer, wines and soft drinks can be extremely small, of the order of 1 ppm or less.

It is therefore of great importance to exclude or keep to an absolute minimum the presence of O₂ (air) in the system during the manufacture, storage, pumping, bottling or canning of many types of these beverages.

This is generally achieved by the use of a relatively inert and inexpensive gas such as nitrogen (N₂) or carbon dioxide (CO₂) or even Argon (Ar) to purge items of equipment, storage tanks, pipelines, canning and bottling lines free of air and to then blanket the liquid product to exclude contact with air during manufacture, storage and packaging.

The choice of whether to use N₂ or CO₂ or a mixture of these two gases can depend on various factors including the compatibility of the gas with the product, solubility, effect on flavour, taste, aroma or bouquet, storage life, etc. For example, N₂ may be the gas preferred for inerting types of wine, whilst CO₂ is usually preferred to inerting the gas space in vessels for carbonated beverages such as beer, soft drinks and various types of wine.

With respect to the use of CO₂ in the wine industry for purging equipment including storage tanks and for blanketing the wine during its manufacture, storage and bottling or canning, one practice is to use the CO₂ in gaseous form at around room temperature and at or above atmospheric pressure. The CO₂ gas may be obtained from transportable high pressure liquid CO₂ containers or by vapourising liquid CO₂ stored in on-site storage vessels operating at pressures ranging from about 650 kPa to about 2100 kPa.

Because the density of gaseous CO₂ at room temperature and at atmospheric pressure is about 50% greater than that of air under the same conditions, it has proved to be very suitable for displacing air from empty wine storage tanks prior to filling and for eliminating or greatly minimising the ingress of air during static storage and during the emptying of these tanks. Also, it is being used on a large scale to displace the air from empty wine bottles and cans prior to filling.

Australian patent 580732 describes methods and apparatus for producing an inert atmosphere above a stored product in a storage vessel. More particularly, Australian patent 580732 describes an apparatus and method for delivering a mixture of CO₂ snow and gaseous CO₂ into the head space of a recently filled bottle. The gaseous CO₂ which is heavier than the air in the head space displaces the air from the bottle. Additionally, the CO₂ gas resulting from the sublimation of the CO₂ snow in the relatively warm bottle displaces any remaining air and then flows gently out of the neck of the bottle, thus preventing air from re-entering the bottle. In this manner the air/oxygen content of the head space at the capping or corking station is significantly reduced when compared to bottles capped following the introduction of only gaseous CO₂ into the head space of the bottle.

Although the method and apparatus disclosed in Australian patent 580732 offers some advantage over prior art arrangements, the present invention seeks to further improve thereon.

The discussion of the background to the invention herein is included to explain the context of the invention. This is not to be taken as an admission that any of the material referred to was published, known or part of the common general knowledge as at the priority date of any of the claims.

### SUMMARY OF THE INVENTION

According to a first aspect of the present invention there is provided a device for use with an apparatus for supplying an inert compound into the head space of a container, the device including a delivery path having an inlet for receiving a mixture of gaseous and solid phase inert compound, an outlet and a tortuous section located between said inlet and said outlet, said tortuous section being arranged to reduce the velocity of said solid phase inert compound as it flows there through.

Preferably, a vent means is formed in the tortuous section so that gaseous phase inert compound can vent from the tortuous section.

The tortuous section may adopt many different forms. However, in one preferred form, the tortuous section includes a curved section, for example a loop, through which the inert compound flows. The loop is preferably substantially circular in shape. In such an embodiment, the venting means may include a vent or slot formed in an inner side thereof.

The tortuous section is preferably shaped so that the gaseous phase inert compound is separated from the solid phase inert compound as it travels there through so that the gaseous phase inert compound can be more readily vented through the venting means.

Preferably, the inert compound delivered from said outlet is of a substantially solid phase.

According to a second aspect of the present invention there is provided an apparatus for supplying an inert compound into an head space of a container, said apparatus including a pathway having an inlet arranged to be connected to a supply of an inert compound in a liquid phase, means for converting said inert compound from a liquid phase to a mixture of solid and gaseous phase inert compound and an outlet arranged to supply inert compound to the head space of the container and wherein a device is provided substantially adjacent the outlet, said device including a delivery path having an inlet for receiving the mixture of solid and gaseous phase inert compound, an outlet and a tortuous section located between said inlet and said outlet, said tortuous section being arranged to reduce the velocity of said solid phase inert compound as it flows there through.

According to a third aspect of the present invention there is provided a method of storing a liquid in a container, said method including the steps of:
(i) partially filling a container with a liquid so that a head space filled with air is formed in an upper part of the container;
(ii) passing an amount of an inert compound through a converting means to convert the inert compound to a mixture of a solid and a gaseous state;
(iii) passing the mixture through a device including a delivery path having an inlet for receiving a mixture of gaseous and solid phase inert compound, an outlet and a tortuous section located between said inlet and said outlet, said tortuous section being arranged to reduce the velocity of said solid phase inert compound as it flows there through; and
(iv) delivering inert compound into the head space of the container.

Preferably, a closure is applied to the container after air and in particular after oxygen has been displaced from the head space. The air and/or oxygen is preferably displaced from the head space as a result of sublimation of the inert compound. Accordingly, the inert compound is denser than air and/or oxygen when the solid phase inert compound has returned to the gaseous phase after sublimation and is at a lower temperature than the ambient air.

The invention further includes a bottling line incorporating an apparatus according to the second aspect of the present invention.

As used throughout this specification, the phrase “inert compound” is used to define any substance that is in gaseous form at atmospheric pressure and at a temperature above 0° C. and which does not react to an unacceptable degree with the other components in the container.

The inert compound delivered is preferably denser than air, at least when the inert compound has returned to the gaseous phase after sublimation. The greater density of the inert compound may be an intrinsic property of the gas (i.e. at atmospheric pressure and temperature the deposited gas has a greater density than air). Alternatively, or in addition, the greater density of the inert compound may be a result of the low temperature thereof after sublimation (i.e. the gas has a greater density then air at the temperature at which it sublimes). The use of an inert compound denser than air enables the method and apparatus of the present invention to be used to create a layer of inert gas above the surface of the liquid in the container, said layer of gas serving to displace any air/oxygen from the head space of the container. This layer is preferably relatively stable and arranged to remain as an effective inerting atmosphere at the liquid surface for a considerable period of time.

The preferred inert compound for many possible applications of the invention is carbon dioxide (CO₂). Carbon dioxide is denser than air when it is in the gaseous phase at standard temperature and pressure. Thus, it will create a layer of an inert gas at the liquid surface due to the density difference. The carbon dioxide is preferably deposited in the head space of the container as solid phase carbon dioxide (CO₂ snow) at about −78.5°. However, it will be appreciated by those skilled in the art that at least a small amount of gaseous carbon dioxide will also be delivered into the head space of the container.

### DESCRIPTION OF THE DRAWINGS

Embodiments of the invention will now be described, by way of example only, with reference to the accompanying drawings in which:

FIG. 1 is a schematic side view of an apparatus according to an embodiment of the invention; and

FIG. 2 is a schematic front view of a venting apparatus according to an embodiment of the invention.

### DETAILED DESCRIPTION OF THE PREFERRED EMBODIMENT

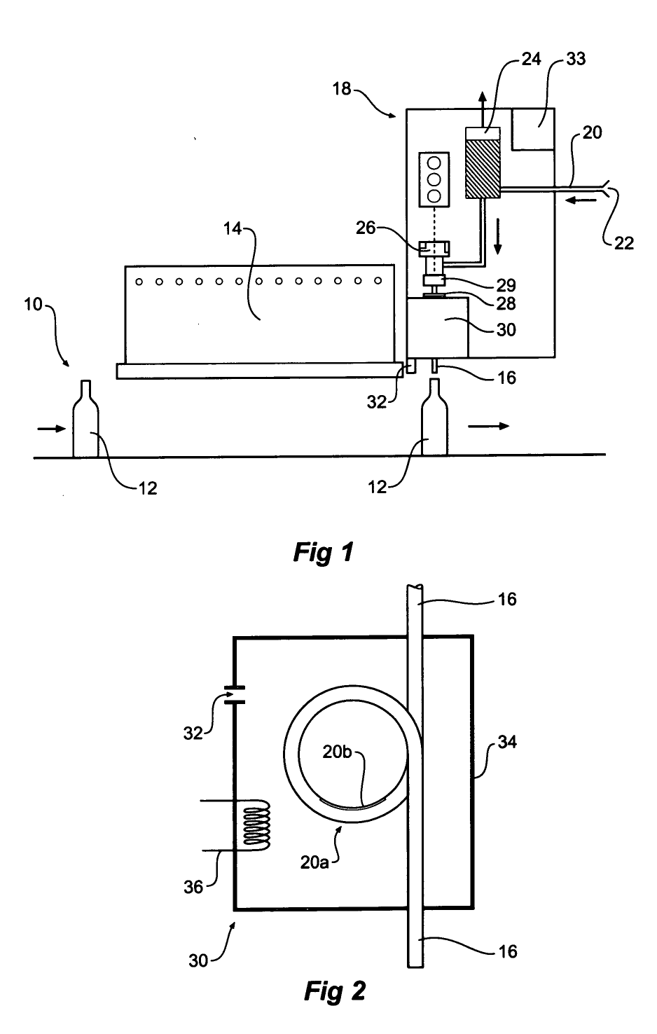

FIG. 1 shows a bottling line 10 for filling bottles 12 with a product such as wine. As shown in this Figure, each bottle 12 passes under a filling station 14 whereat the bottle 12 is charged with a liquid such as wine. Each filled bottle 12 then passes under an outlet nozzle 16 of an inerting apparatus 18. The inerting apparatus 18 delivers an amount or charge of inerting compound into the head space of the filled bottle 12. In this embodiment, the inerting apparatus 18 delivers an amount of solid phase CO₂ (hereinafter referred to as CO₂ snow) into the head space of the bottle 12. A small amount of gaseous CO₂ may also be delivered into the head space of the bottle 12. As the CO₂ snow settles and/or comes into contact with the wine in the bottle 12, sublimation takes place causing displacement from the head space of the bottle 12 of air/oxygen. The resulting cold dense CO₂ gas then acts to prevent any substantial reintroduction of air/oxygen into the headspace of the bottle 12 prior to capping at a capping station (not shown). Preferably, sublimation of the CO₂ snow is almost completed by the time the cap/closure is applied to the bottle 12.

The inerting apparatus 18 includes a fluid pathway 20 having an inlet 22 arranged to be connected to a supply of liquid CO₂ (not shown). The supply of liquid CO₂ may be contained in either a portable or static bulk vessel with an operating pressure typically of 1500 kPa. Fluid flows from the inlet 22 to a gas eliminator 24 which vents to atmosphere. The gas eliminator 24 feeds almost pure liquid CO₂ to a solenoid valve 26 and expansion orifice 28. The CO₂ snow and gas exiting from the expansion orifice 28 then pass through a device 30, hereafter referred to as a venting apparatus 30. In the venting apparatus 30 as much of the CO₂ gas as possible is vented from the pathway 20 so that the inert compound delivered through the outlet nozzle 16 to the head space of the bottle 12 is mostly of a solid phase (i.e. CO₂ snow).

The proportion of CO₂ snow produced depends on the initial temperature of the liquid CO₂ entering the solenoid valve 26 and expansion orifice 28. The colder the liquid CO₂, the greater the proportion of CO₂ snow produced. For example, liquid CO₂ at a temperature of −16.8° C. produces about 46% of its weight as snow, whilst liquid CO₂ at a temperature of −46.3° C. produces about 56% of its weight as snow.

A heater 29, for example a band heater, is provided on or adjacent to the solenoid valve 26 so as to enable control of the temperature of the valve 26.

The heater 29 enables control of the temperature of the liquid CO₂ and thus, as mentioned above, the proportion of CO₂ snow produced.

The operation of the solenoid valve 26, which determines the timing and quantity of the CO₂ snow delivered to the expansion orifice 28 and thus the bottle 12, is controlled by a sensor 32 and a control system 33. The control system 33 may include a PLC.

In the illustrated embodiment, the sensor 32 is located adjacent the inerting apparatus 18 and is in the form of an optical sensor. The sensor 32 activates the control system 33 allowing CO₂ snow to be delivered to the head space of the bottle 12. In a preferred embodiment of the invention, the control system 33 enables four individual injection times and consequently four different CO₂ snow quantities. The preferred injection times are 0.04 seconds delivering 0.38 grams of snow, 0.06 seconds delivering 0.57 grams of snow, 0.08 delivering 0.76 grams of snow and 0.10 seconds delivering 0.95 grams of snow to the head space of the bottle 12. The control system 33 can also be set for continuous operation. The control system 33 also controls the temperature of the heater 29.

The venting apparatus 30 includes a stainless steel enclosure 34 that is vented to allow for the dispersion of gaseous CO₂. Housed within the enclosure 34 is a portion of the pathway 20 that has a tortuous section 20a. As best shown in FIG. 2, the tortuous section 20a takes the form of a circular shaped loop. In accordance with one preferred embodiment of the invention, the pathway 20 is made from stainless steel tube having a 10 mm inner diameter and the circular shaped loop has a diameter of 150 mm. Although the diameter of the loop of this embodiment is 150 mm, it is envisaged that a diameter of between 100 and 250 mm could be effective. The diameter of the loop is constrained by size limitations of the inerting apparatus 18 and also by the desired ratio of CO₂ snow/CO₂ gas at the outlet nozzle 16. It is normally preferable to have the highest level of CO₂ snow possible, but it is recognised that a small quantity of CO₂ gas will normally be present at the outlet nozzle 16.

As best depicted in FIG. 2, the curved section or loop 20a of the pathway 20 includes a venting means 20b. The venting means 20b includes as a slot 20b cut or formed in an inner wall portion of the loop 20a. The slot 20b is positioned and sized so that CO₂ gas can pass from the loop 20a through the vent 20b and then out to atmosphere. In accordance with one preferred embodiment of the invention wherein the loop has a diameter of 100 mm, the slot which forms the vent 20b extends over an arc of approximately 65°. The slot has a width of approximately 5.5 mm.

The loop 20a causes the CO₂ snow to follow the outer side of the loop radius, whilst the gas follows the inner side of the loop radius. Thus, the gaseous CO₂ is separated from the CO₂ snow and can more efficiently vent through the slot 20b.

Most of the gaseous CO₂ flows out of the slot 20b as the CO₂ snow is pushed through the pathway 20 to the outlet nozzle 16. The gaseous CO₂ flows out of the venting apparatus 30 via a vent 35. The flow of CO₂ snow meanwhile continues around the loop 20a and arrives at the outlet nozzle 16 at a greatly reduced velocity. The velocity of the CO₂ snow is reduced because of the pressure drop at the slot 20b and also because of the diameter and shape of the loop 20a (i.e. the inclusion of the tortuous section 20a). Accordingly, the CO₂ snow can be delivered to the head space of the bottle 12 at a lower velocity. This is advantageous because it increases the efficiency of the CO₂ snow in displacing the air out of the head space of the bottle 12.

The CO₂ snow is also delivered in a more “compact” form and thus the dosage to the head space of the bottle 12 can be more accurately controlled. The “compact” form of the CO₂ snow is important so as to prevent the snow injection angle into the bottle 12 from being too large. If the snow injection angle is too large, snow will be spilled over both sides of the neck of the bottle 12. This is wasteful and more importantly prevents accurate dosing of the head space of the bottle 12. Precise control of the amount of CO₂ snow delivered to the head space of the bottle 12 is desirable as it enables the amount of air/oxygen left in the head space after capping to be controlled. Thus, the level of gaseous or dissolved oxygen in the product in the bottle 12 can be maintained at a predetermined level.

It will be appreciated that the venting means 20b may not remove all of the gaseous CO₂ and that accordingly some gas will be flow out of the outlet 16. However, the amount of gas will be greatly reduced as compared to the amount of gas in the mixture entering the venting apparatus 30. Thus, the inclusion of the vent 20b increases the efficiency and accuracy of the CO₂ snow delivery to the head space of the bottle 12.

The atmosphere within the enclosure 34 is heated by an air heater 36 that is controlled by the control system 33. The enclosure atmosphere is heated to prevent blockages in the section of the pathway 20 within the enclosure 34 and to also prevent blockage of the vent 20b.

Although not illustrated in the Figures, a reducing union may be located between the inlet 22 and the gas eliminator 24. A relief valve may also be provided to relieve excess pressure within the pathway 20.

The components of the inerting apparatus 18 are contained within an enclosure which is preferably made of stainless steel. The enclosure may be free standing or suitable for mounting on a wall surface, floor or stand.

The described embodiment of the invention is advantageous over prior art arrangements because it delivers the CO₂ snow to the outlet nozzle 16 at a reduced velocity. Additionally, because of the inclusion of the vent 20b, a higher proportion of CO₂ snow is delivered to the outlet nozzle 16, thereby making dosing of the head space of the bottle 12 more accurate. The inerting apparatus 18 is also suitable for use on high speed bottling lines.

Although the embodiment of the invention has been described in relation to filled containers, such as wine bottles, it will be appreciated that the invention is not restricted to such applications. The invention may be used in conjunction with storage vessels, cans, cartons etc for many different liquids. The invention may also be used in connection with empty containers, such as empty bottles or cans (i.e. can be used pre fill or post fill).

The described embodiment includes a tortuous section 20a which takes the form of a circular loop 20a. However, it is recognised that the tortuous section 20a may adopt different forms. For example, it is envisaged that other shaped paths may result in a decrease in the velocity of the solid phase inert compound passing there through. It is also envisaged that a path with barriers or protrusions extending from the inner walls of the path may also serve to decrease the velocity of the solid phase inert compound.

In the present embodiment the vent 20b is described as a slot. However, it will be appreciated by those skilled in the art that the vent may adopt other forms. For example, the vent may take the form of a scoop (i.e. an angled and curved protuberance extending inside of the loop).

The embodiments have been described by way of example only and modifications within the spirit and scope of the invention are envisaged.

1-17. (canceled)

18. An apparatus which may be used for supplying an inert compound into the head space of a container, said apparatus comprising a pathway, wherein said pathway comprises:
a) an inlet, wherein said inlet receives a mixture of gaseous phase and solid phase inert compound;
b) an outlet; and
c) a tortuous section, wherein:
1) said tortuous section is substantially located between said inlet and said outlet;
2) said compound passes through said tortuous section; and
3) said tortuous section reduces the velocity of said solid phase inert compound.

19. The apparatus of claim 18, wherein said tortuous section comprises a curved section through which said compound flows.

20. The apparatus of claim 19, wherein said curved section forms a loop.

21. The apparatus of claim 20, wherein said loop is substantially circular.

22. The apparatus of claim 18, further comprising a vent means, wherein said vent means:
a) is located in said tortuous section; and
b) vents said gaseous phase inert compound from said tortuous section.

23. The apparatus of claim 22, wherein said vent means comprises a vent or slot located on an inner surface of said tortuous section.

24. The apparatus of claim 22, wherein:
a) said tortuous section comprises a circular loop; and
b) said vent means is located on an inner surface of said loop radius.

25. The apparatus of claim 24, wherein said loop has a diameter between about 100 mm to about 250 mm.

26. The apparatus of claim 25, wherein said venting means extends over about a 65° arc length of said loop.

27. The apparatus of claim 25, wherein said vent means comprises a slot.

28. The apparatus of claim 27, wherein said slot has a width of about 5.5 mm.

29. An apparatus which may be used for supplying an inert compound into the headspace of a container, said apparatus comprising:
a) a first pathway, wherein said first pathway comprises:
1) a first inlet which may be connected to a supply of an inert compound in a liquid phase;
2) a converting means for converting said liquid phase inert compound to a mixture of gaseous phase and solid phase compound; and
3) a first outlet; and
b) a second pathway, wherein said second pathway comprises:
1) a second inlet, wherein said second inlet:
i) is located substantially adjacent to said first outlet; and
ii) receives said mixture of gaseous phase and solid phase compound;
2) a second outlet; and
3) a tortuous section, wherein:
i) said tortuous section is substantially located between said second inlet and said second outlet;
ii) said mixture of gaseous phase and solid phase compound asses through said tortuous section; and
iii) said tortuous section reduces the velocity of said solid phase inert compound.

30. The apparatus of claim 29, wherein said tortuous section comprises a curved section through which said compound flows.

31. The apparatus of claim 30, wherein said curved section forms a loop.

32. The apparatus of claim 31, wherein said loop is substantially circular.

33. The apparatus of claim 29, further comprising a vent means, wherein said vent means:
a) is located in said tortuous section; and
b) vents said gaseous phase inert compound from said tortuous section.

34. The apparatus of claim 33, wherein said vent means comprises a vent or slot located on an inner surface of said tortuous section.

35. The apparatus of claim 33, wherein:
a) said tortuous section comprises a circular loop; and
b) said vent means is located on an inner surface of said loop radius.

36. The apparatus of claim 35, wherein said loop has a diameter between about 100 mm to about 250 mm.

37. The apparatus of claim 36, wherein said venting means extends over about a 65° arc length of said loop.

38. The apparatus of claim 36, wherein said vent means comprises a slot.

39. The apparatus of claim 38, wherein said slot has a width of about 5.5 mm.

40. An apparatus which may be used as a bottling line, said apparatus comprising:
a) a bottling line; and
b) a supply system for an inert compound, wherein said supply system comprises:
1) a first pathway, wherein said first pathway comprises:
i) a first inlet which may be connected to a supply of an inert compound in a liquid phase;
ii) a converting means for converting said liquid phase inert compound to a mixture of gaseous phase and solid phase compound; and
iii) a first outlet; and
2) a second pathway, wherein said second pathway comprises:
i) a second inlet, wherein said second inlet:
aa) is located substantially adjacent to said first outlet; and
bb) receives said mixture of gaseous phase and solid phase compound;
ii) a second outlet; and
iii) a tortuous section, wherein:
aa) said tortuous section is substantially located between said second inlet and said second outlet;
bb) said mixture of gaseous phase and solid phase compound passes through said tortuous section; and
cc) said tortuous section reduces the velocity of said solid phase inert compound.

41. The apparatus of claim 40, further comprising:
a) a control system for controlling said supply system; and
b) a sensor, wherein said sensor is arranged to activate said control system so that said inert compound is delivered to the head space of a container on said bottling line.

42. A method which may be used for storing a liquid in a container, said method comprising:
a) partially filling a container with a liquid such that a head space filled with air is formed in an upper part of said container;
b) sending an amount of an inert compound through a converting means, wherein said converting means converts said inert compound to a mixture of gaseous phase and solid phase compound;
c) sending said mixture of gaseous phase and solid phase compound through a device, wherein:
1) said device comprises a delivery path; and
2) said delivery path comprises:
i) an inlet for receiving said mixture;
ii) an outlet; and
iii) a tortuous section, wherein:
aa) said tortuous section is substantially located between said inlet and said outlet;
bb) said mixture of gaseous phase and solid phase compound passes through said tortuous section; and
cc) said tortuous section reduces the velocity of said solid phase inert compound; and
d) delivering said mixture of gaseous phase and solid phase compound into said head space.

43. The method of claim 42, further comprising:
a) displacing air or oxygen from said head space; and
b) closing said container after said displacement.
